(19) United States
(12) Patent Application Publication
(10) Pub. No.: US 2010/0280903 A1
(43) Pub. Date: Nov. 4, 2010

(54) DOMAIN CLASSIFICATION AND CONTENT DELIVERY

(75) Inventors: DAVID BARLIN, SEATTLE, WA (US); RICHARD EDWARD WRIGHT, SEATTLE, WA (US); MICHAEL DIETRICH SCHACKWITZ, PLEASANTON, CA (US); JOOST MARTIJN BON, SEATTLE, WA (US); BRIAN DAVID HOLDSWORTH, WOODINVILLE, WA (US); MICHAEL CLIFFORD KUNZ, SEATTLE, WA (US); GERARD GJONEJ, SEATTLE, WA (US); ERIK ZIGMAN, SAMMAMISH, WA (US); SHENGYU FU, KIRKLAND, WA (US); VINCENZO MARIA DI NICOLA, KIRKLAND, WA (US); DENISE DARE HUI, SAN MATEO, CA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/432,831

(22) Filed: Apr. 30, 2009

(51) Int. Cl. G06Q 30/00; G06F 17/30; G06F 7/06; G06F 15/16

(52) U.S. Cl. 705/14.58; 709/206; 707/E17.014; 707/E17.044; 705/14.66

(57) ABSTRACT

Methods, systems, and computer-readable media for categorizing sender domains are provided. An advertisement platform includes targeting components, databases, mail servers, and client devices. Recipients interact with the client devices to receive electronic mail from the mail servers. The mail servers store records of sender domains where the recipient performed a specified action to a message having a sender domain. The mail server transmits a log of the sender domains, actions, and an anonymous identifier for the recipient to the targeting system. The targeting components extract the sender domains that are used by the advertisement platform to communicate to the database to retrieve advertisement categories that correspond to the sender domains. The advertisement categories are used by the advertisement platform to direct content, including advertisements, to the recipients via the anonymous identifier.

### BACKGROUND

Conventionally, advertisements are targeted to potential consumers based on criteria established by advertisers or observed by advertisement platforms. Advertisement platforms executing on servers on the Internet may allow the advertisers to deliver advertisements based on contextual targeting, demographic targeting, or behavioral targeting. The potential consumers may receive the advertisements on a personal computer that connects to the Internet. The conventional advertisement platforms may expose a potential consumer's sensitive information, including browsing activities and demographic information, at risk because the advertisement platforms may collect and analyze the sensitive information for each potential consumer.

The advertisement platforms may provide contextual targeting by processing content on a web page, where the advertisement will be rendered by the potential consumer's personal computer. The advertisement platforms determine the immediate context of the web page by extracting phrases and terms from the content. When the extracted phrases and terms match keywords purchased by the advertiser, advertisements promoting goods or services of the advertiser are selected by the advertisement platform. The selected advertisements are delivered to the personal computer for rendering on the web page having the extracted phrases and terms.

The advertisement platforms may provide behavioral targeting by observing a potential consumer's interaction with content on a web page. The advertisement platforms predict a potential consumer's intent. For instance, when a mouse controlled by the potential consumer repeatedly hovers over a particular item within a specified period of time, the advertisement platforms may predict that the potential consumer intends to purchase the particular item. In turn, the advertisement platform may select an advertisement corresponding to the particular item and deliver the advertisement for rendering on the personal computer.

The advertisement platforms may provide demographic targeting by receiving characteristics of an intended audience of the advertisement from an advertiser. The characteristics may include demographic characteristics, such as, age, gender, income, etc. The advertisement platforms may receive a potential consumer's demographic characteristics from the personal computer. Advertisements for advertisers whose intended audience characteristics match the received potential consumer's demographic characteristics are selected by the advertisement platform and delivered for rendering to the personal computer.

### SUMMARY

Embodiments of the invention overcoming these and other problems in the art relate in one regard to an advertisement platform, computer-readable media, and computer-implemented method to categorize sender domains. The advertisement platform categorizes sender domains and targets content, including advertisements, to recipients of messages having one of the categorized sender domains, where the recipients performed a specified action upon receipt of the message. The advertisement platform targets the content to the recipients and simultaneously protects the privacy of the recipients.

The advertisement platform is a server computer that executes, among other components, a targeting component, an anonomizer component, an analysis component, an advertisement selection component, and a delivery engine component. The targeting component receives a log having a recipient's anonymous identifier, each sender domain read by the recipient, and a corresponding action performed by a recipient of each sender domain. The anonomizer component extracts the anonymous identifier from the log and retrieves a profile of the recipient from an identification system. The analysis component processes the sender domains and corresponding actions to categorize each sender domain. The advertisement selection component receives advertiser categories corresponding to each sender domain from the analysis component. Also, based on the received advertiser category, the advertisement selection component selects appropriate content, including advertisements from an advertisement database, and updates a profile stored by the identification system. The delivery engine component, receives the appropriate content selected by the advertisement selection component and schedules the appropriate content for delivery to the recipient.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 is a network diagram that illustrates an exemplary computing system in accordance with embodiments of the invention;

FIG. 2 is a component diagram that illustrates an exemplary advertisement platform in accordance with embodiments of the invention;

FIG. 3 is a data model diagram that illustrates an exemplary taxonomy in accordance with embodiments of the invention;

FIG. 4 is a structural diagram that illustrates an exemplary recipient profile in accordance with embodiments of the invention;

FIG. 5 is a logic diagram that illustrates a computer-implemented method to identify advertiser categories for sender domains in accordance with embodiments of the invention; and

FIG. 6 is a logic diagram that illustrates a computer-implemented method to target advertisement based on sender domains in accordance with embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, or firmware. The term “content” refers to text, graphics, audio, video, advertisements, drivers, software, or any other multimedia. Also, as utilized herein, the term “recipient” refers to a user of at least one computing device that receives messages, such as, electronic mail having a sender domain.

Embodiments of the invention provide an advertisement platform that targets advertisements to recipients without exposing sensitive information. The advertisement platform may select relevant advertisements that target each recipient by identifying advertiser categories for each sender domain included in messages received by each recipient.

In one embodiment, an advertisement platform may retain the relevance contained in each sender domain and corresponding recipient actions by receiving logs of the sender domains and associated recipient actions. For instance, when a recipient receives and subsequently reads an electronic message, the recipient's action may declare an interest in content of the electronic message. The advertisement platform captures the relevance of the sender domain to the recipient by analyzing the log. The advertisement platform maintains privacy standards by not processing the content of the electronic messages or electronic mail received and read by each recipient. The retained sender domains and corresponding actions may allow the advertisement platform to target advertisements to the recipients, where the targeted advertisements are relevant to the interests of the recipient.

In some embodiments, a computer system that targets advertisement to recipients includes senders, recipients, client devices, and advertisement platforms. The senders generate messages having sender domains and transmit the messages to the recipients. The recipients access the messages at the client devices. Each recipient may perform an action on the received message at a client device. For instance, a recipient may perform a delete action or a read action. In certain embodiments, the client device may store each message that is read by the recipient in a log. In turn, the client device may send the log having each sender domain, where the recipient read the message to the advertisement platform. The advertisement platform may process the log to derive targeting information based on the sender domain of the received message and to select advertisements for delivery to the recipients.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

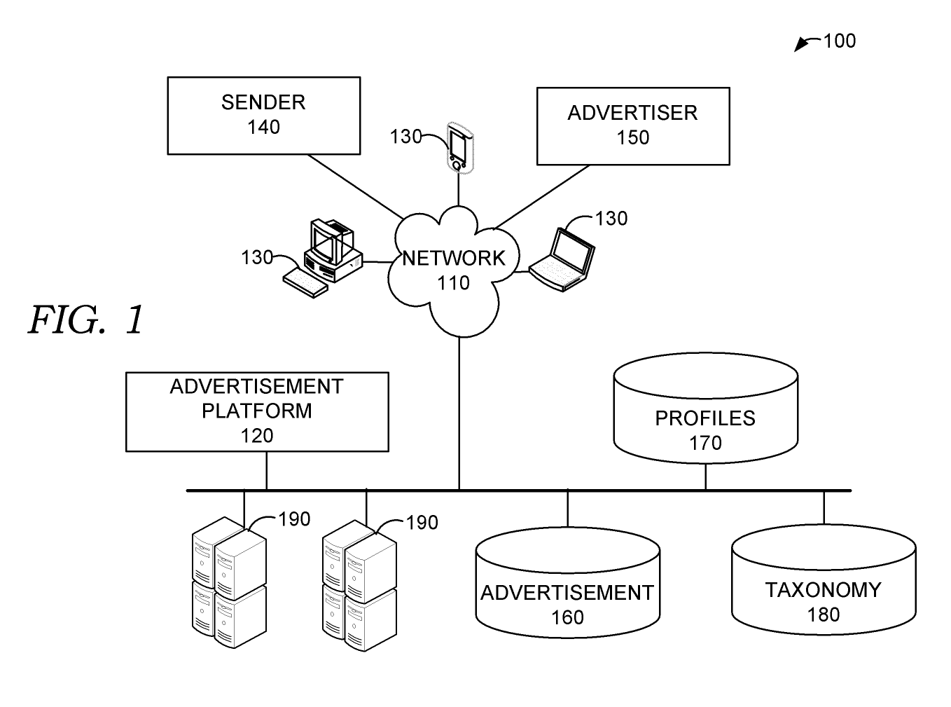

FIG. 1 is a network diagram that illustrates an exemplary computing system in accordance with embodiments of the invention. The computing system 100 includes a network 110, an advertisement platform 120, client devices 130, a sender 140, an advertiser 150, an advertisement database 160, profiles database 170, taxonomy database 180, and messaging servers 190.

The network 110 is configured to facilitate communication between the client devices 130 and the sender 140. The network 110 also facilitates communication between the advertisement platform 120, the advertiser 150, the sender 140, and the messaging servers 190. The network 110 may be a communication network, such as a wireless network, local area network, wired network, or the Internet. In an embodiment, the client devices 130 interact with the sender 140 utilizing the network 110 and the messaging servers 190. The sender 140 provides messages that include electronic mail to recipients that operate the client devices 130.

The advertisement platform 120 categorizes sender domains contained in messages received by the client devices 130. In some embodiments, the messages are generated by the sender 140 and the recipients at the client devices 130 receive the messages by accessing the messaging servers 190. The advertisement platform 120 may receive a log having the sender domains of each message that a recipient at the client devices 130 opened and read. In an embodiment, the log is generated and stored by the client devices 130. In an alternate embodiment, the log is generated and stored by the messaging servers 190. In turn, the advertisement platform 120 categorizes the sender domains and identifies one or more advertiser categories that correspond to a full sender domain derived by the advertisement platform from the sender domains included in the log.

In certain embodiments, the advertisement platform 120 interfaces with the client devices 130 to deliver relevant advertisements to the recipients. The advertisement platform 120 may receive a request for an advertisement from an application executing on the client device 130. The request for the advertisement may include an anonymous identifier (ANID) that corresponds to the recipient that operates the client device 130. The anonymous identifier is linked to a recipient profile that is used to select relevant advertisements. The advertisement platform 120 traverses the advertisement database 160 to select one or more advertisements for delivery based on the recipient profile. Upon locating an appropriate advertisement that matches the recipient profile, the advertisement platform 120 delivers that advertisement to the client devices 130.

In an embodiment, if the request from the client device 130, does not contain the ANID, the advertisement platform 120 selects a relevant advertisement by using context, behavior, timing, proximity, or performance to select the advertisement for delivery to the client device. The advertisement platform 120 may use context to select the advertisement for delivery to the client device 130. The advertisement platform 120 may receive terms or phrases from an application executing on the client device 130. The application may send the terms or phrases of content that is currently in focus at the client device 130 to the advertisement platform 120. Alternatively, the application may send the terms or phrases of content that is in the background and not currently in focus at the client device 130 to the advertisement platform 120. The terms or phrases received from the application are used by the advertisement platform to select advertisements that match the received terms or phrases. In turn, the selected advertisements are scheduled for delivery to the client devices 130.

The advertisement platform 120 may use behavior to select the advertisement for delivery to the client device 130. The advertisement platform 120 may receive terms or phrases that represent content that the recipient has repeatedly used or clicked on at the client device 130. The terms or phrases received from the client device 130 are used by the advertisement platform to select advertisements that match the received terms or phrases. In turn, the selected advertisements are scheduled for delivery to the client devices 130.

The advertisement platform 120 may use timing to select the advertisement for delivery to the client device 130. The advertisement platform 120 may receive a time provided by a clock local to the client device 130. When the local clock specifies a particular time of day, season, or festive day, a corresponding advertisement is selected for delivery by the advertisement platform 120. For instance, when the local clock at the client device 130 transmits a time that corresponds to morning, the advertisement platform may select a breakfast or coffee advertisement. In some embodiments, the local clock at the client device 130 may transmit times corresponding to recipient configured alarms or calendar events to the advertisement platform 120, which matches the terms or phrases in the alarms or calendar events with advertisements stored in the advertisement database 160.

The advertisement platform 120 may use proximity to select the advertisement for delivery to the client device 130. The advertisement platform 120 may receive a location provided by a geolocator associated with the client device 130. When the geolocator specifies a particular location, a corresponding advertisement is selected for delivery by the advertisement platform 120. For instance, when the geolocator of the client device 130 transmits a location that corresponds to London, the advertisement platform may select a advertisement for an advertiser having a presence in London.

The advertisement platform 120 may use performance to select the advertisement for delivery to the client device 130. The advertisement platform may select an advertisement having the highest conversion rate, and deliver the advertisement to the client device. The conversion rate is a number of purchases by recipients that link back to the advertisements over a total number of impressions of the advertisement by all recipients.

In some embodiments, the advertisement platform 120 may further filter the advertisements selected using the ANID included in the request received from the client device based on context, behavior, timing, proximity, and performance.

The advertisement platform 120 also interfaces with the advertisers 150 to allow the advertisers 150 to submit advertisements to the advertisement platform 120. The advertisers 150 provide the advertisement platform 120 with keywords, targeting data, and bids that correspond to content that is consumed by a recipient. The targeting data may include demographics, geographic locations, and timing to criteria to control delivery of the advertisements to recipients that are likely to interact with the advertisement. The advertisements, keywords, targeting data, and bids are stored in the advertisement database 160. The advertisement platform 120 processes the requests received from the client devices 130 and the keywords, targeting data, and bid provided by the advertisers 150 to select a set of appropriate advertisements stored in the advertisement database 160 for delivery to the client devices 130.

The client devices 130 are utilized by recipients to access messages stored on the messaging servers 190. The messaging servers 190 transmit messages to the client devices 130. The recipients may read, delete, or perform any other appropriate action to the messages received from the messaging servers 190. The messages are displayed by an email application executing on the client device 130. In some embodiments, advertisements are received from the advertisement platform 120 by an advertisement application executing one the client device 130. The client devices 130 include, without limitation, personal digital assistants, mobile devices, smart phones, laptops, personal computers, gaming systems, set-top boxes, or any other suitable client computing device. In one embodiment, the client devices 130 are advertisement-funded client devices that are configured to display advertisements as part of the graphical user interface provided by the operating system of the client devices 130. The client devices 130 include recipient and system information storage to store recipient and system information on the client devices 130. The recipient information may include search histories, cookies, ANIDs, logs, and passwords. The system information may include internet protocol addresses, cached Web pages, geographical locations, calendar events, time of day, and system utilization. In some embodiments, the advertisement application executing on the client devices 130 transmits an ANID for the recipient to the advertisement platform 120. In turn, the advertisement platform 120 selects an appropriate advertisement for delivery to the client device 130.

The sender 140 is a computing device. The sender 140 generates messages that are delivered to recipients operating the client devices 130. The messages include a sender domain that identifies the sender 140. In some embodiments, the messages are electronic mail messages that are stored at the messaging server 190. The sender 140 is communicatively connected to the messaging server 190 via network 110.

The advertiser 150 is a computing device. The advertiser 150 is communicatively connected to the advertisement platform via the network 110. The advertiser 150 provides targeting data, keywords, bids for keywords, bids for targeting data, and advertisements to the advertisement platform 120. The advertiser 150 promotes goods or services with the advertisements. The advertisement platform 120 stores the received advertisements in the advertisement database 160 and delivers advertisements to the client devices 130.

The advertisement database 160 stores advertisements. The advertisement database 160 is created based on the advertisements received from the advertiser 150. In an embodiment, the advertisement database 160 is a relational database or an object-oriented database. The advertisement database 160 also stores the keywords, targeting data, and bids associated with each advertisement. In some embodiments, the advertisements are banner advertisements, display advertisements, text, images, contextual advertisements, search advertisements, audio advertisements, or mobile advertisements that describe a good, service or thing that an advertiser wishes to promote to users. The things described in the advertisements may include events and items from all over the world, from various merchants, and from various distributors. The advertisements are selected by the advertisement platform 120 and transmitted to the client devices 130.

The profiles database 170 stores recipient data. The recipients that operate the client devices 130 provide explicit user information at a registration server (not shown) for storage in the profiles database 170. The explicit user information may include mailing address, name, age, gender, etc. The profiles database 170 is also updated with implicit user information that is provided by the advertisement platform 120 based on the categorized sender domains associated with each recipient. In an embodiment, the profiles database 170 is a relational database or an object-oriented database. The profiles database 170 stores the ANID for each recipient. In an embodiment, the ANID is a one-way hash of authentication data that includes a user name or password selected by the recipient. For instance, the hash may be a Diffie-Hellman algorithm that is applied to the authentication data. In some embodiments, the profiles database 170 stores explicit recipient data and implicit recipient data for each ANID. The profiles database 170 is accessed by the advertisement platform 120 to retrieve the explicit recipient data and implicit recipient data and to locate advertisements stored in the advertisement database 160 that match the explicit recipient data and implicit recipient data.

The taxonomy database 180 stores mappings between a full sender domain derived from the sender domains and advertiser categories. The mappings may be stored in a hierarchical tree structure. The tree structure may include a plurality of nodes. The tree structure includes inclusion nodes and exclusion nodes that categorize the full sender domains into corresponding children nodes that include industry segment nodes, geographic segment nodes, competitor nodes, and spammer nodes. The full sender domain may be categorized using any of the children nodes. In certain embodiments, the taxonomy database 180 is a relational database or an object-oriented database.

The messaging servers 190 are messaging servers. In an embodiment, the messaging servers 190 store messages transmitted from sender 140 and destined to recipients that operate the client devices 130. The recipients are authenticated at the messaging server 190 with user names and passwords. The messaging servers 190 verify the user names and passwords before providing the recipients with access to the messages. In one embodiment, the messaging server 190 records the interaction of each recipient that accesses the stored messages. The messaging server 190 may receive an ANID for each recipient from the client devices 130. In turn, the messaging server 190 records sender domains of the messages and actions performed by recipients of messages generated by the sender 140. The messaging server 190 creates a log to store each ANID, the sender domains of each message received by a recipient associated with each ANID, and the actions performed by each recipient linked to each ANID. The actions include, but are not limited to, any combination of read, forward, junk, delete, save, print, etc. The messaging server 190 transmits the log to the advertisement platform 120 to classify the sender domains and to update recipient profiles stored in the profiles database 170, where the updated profiles correspond to the received ANIDs. In some embodiments, the messaging server 190 is a mail server.

Accordingly, the computing system 100 is configured with a sender 140 that generates messages that include sender domains. The sender domains are classified by the advertisement platform 120, which selects advertisements for delivery to the client devices 130 based on the sender domain mappings retrieved from a taxonomy database 180, performance of advertisements stored in an advertisement database 160, and matches with the advertiser keywords or targeting data associated with the selected advertisements. The advertisement platform 120 selects an appropriate advertisement for delivery to the client devices 130.

In some embodiments, an advertisement platform delivers advertisements to a client device based on sender domains of messages accessed by the client device. The advertisement platform communicates with a mail server to access the messages. The mail server may record a recipients interaction with messages in a log. In turn, the log is transmitted to the advertisement platform to identify advertiser categories that are related to the sender domain. The advertisement platform selects advertisement for delivery to the client devices based on the identified advertiser categories.

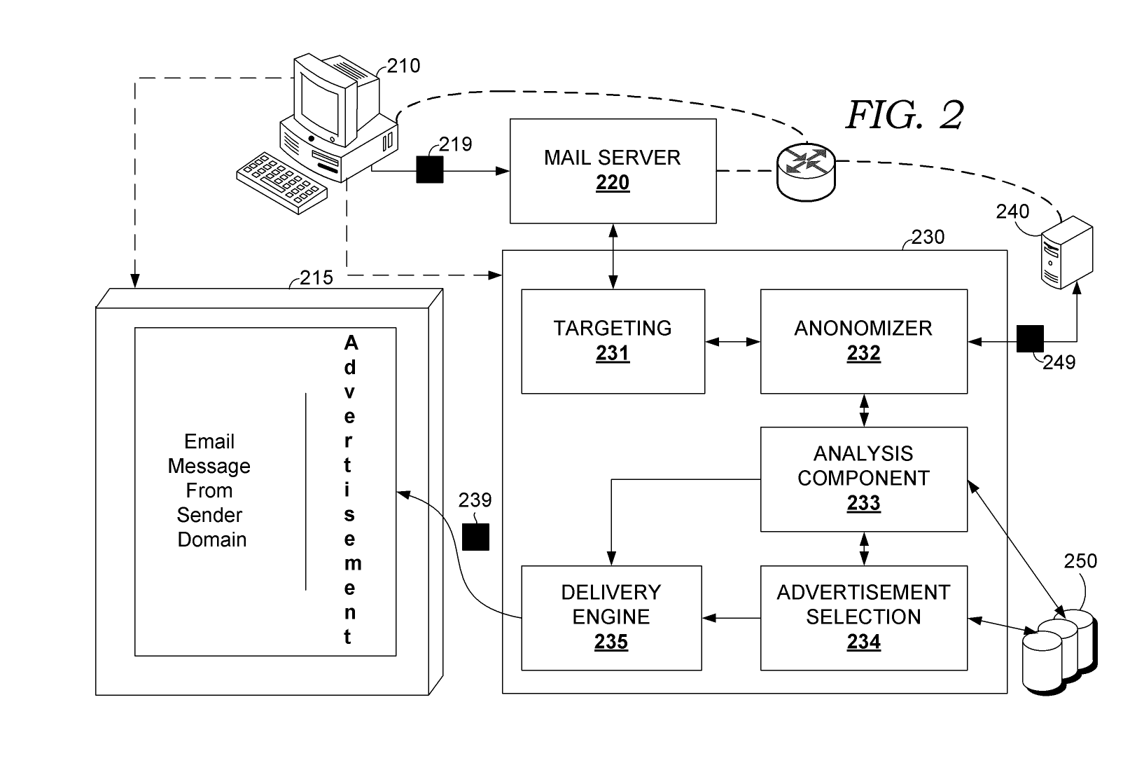

FIG. 2 is a component diagram that illustrates an exemplary advertisement platform 230 in accordance with embodiments of the invention. The advertisement platform 230 is communicatively connected to a client device 210, a mail server 220, identification system 240, and databases 250.

The client device 210 allows an authenticated recipient to retrieve messages stored on the mail server 220. The client device 210 may record actions performed by an authenticated recipient on the retrieved messages in a log 219. The actions an authenticated recipient may perform on the retrieved messages include, among other actions, read, forward, delete, junk, save, and print. The client device 210 protects that privacy of the messages and recipient by not storing any portion of the body of the message in the log 219. The client device 210 stores the sender domain in the log 219 and the corresponding actions performed by the recipient on a message having the sender domain. The client device 210 may store a personal user name and personal password (PUID) for the authenticated recipient in the log 219 along with the sender domain and the corresponding actions. The PUID may be transferred to the identification system 240, which provides an anonymous identifier (ANID) that corresponds to the PUID. In some embodiments, the client device 210 stores an ANID for the authenticated recipient in the log 219 along with the sender domain and the corresponding actions. The ANID allows the recipient to be identified without any personal identifying information. The client device 210 may transmit the log 219 to the advertisement platform 230. In one embodiment, the client device 210 transmits the log 219 directly to the advertisement platform 230. In another embodiment, the client device 210 transmits the log 219 to the mail server 220, which transmits the log 219 to the advertisement platform 230. In turn, the advertisement platform 230 processes the ANID and the log 219 to target advertisements to recipients as the recipients interact with different applications (e.g. email, search, purchase, word processing, etc.) on the client device 210. The client device 210 receives advertisements from the advertisement platform 230. The client device 210 renders the received advertisements 239 on a rendering device 215. In some embodiments, the rendering device 215 is a display.

The mail server 220 transmit messages to client devices 210 operated by the authenticated recipients. The messages include electronic mail that are addressed to the authenticated recipient. In some embodiments, the mail server 220 receives a log 219 from the client devices. The mail server 220 may filter the log 219 to remove entries where a message was deleted or junked without reading. The mail server 220 transmits the filtered log 219 to the advertisement platform 230. In other embodiments, the mail server creates a log similar to log 219, when the client device 210 does not create log 219. The mail server 220 obtains the ANID for each authenticated recipient that accesses messages and performs an action. The mail server 220 records the ANID, the sender domains of messages received by the authenticated recipient associated to the ANID, and the actions performed by the authenticated recipient in a log similar to log 219. The actions may include reply, reply to all, add to favorites, label, forward, delete, etc. The mail server 220 may filter the created log, as discussed above, and transmit the filtered log to the advertisement platform 230. In certain embodiments, the mail server stores safe lists that identify sender domains. The sender domains in the safe lists are selected by authenticated recipients. The senders associated with the selected sender domains are authorized to send messages to the recipient; so, the mail server 220 does not place a message having the selected sender domain in a junk folder. The mail server 220, may transmit the safe list to the advertisement platform 230, along with an ANID that corresponds to the recipient that created the safe list, and the actions performed on the messages having a selected sender domain. In one embodiment, the mail server 220 stores the actions of the selected sender domains in the safe list. In another embodiment, the mail server 220 extracts the actions for each selected domain from log 219, which is received from the client device 210. In turn, the mail server 220 updates the safe list with the extracted actions. Accordingly, the advertisement platform 230 may categorize the sender domains included in the safe list.

The advertisement platform 230 receives an ANID from the client device 210. In some embodiments, the advertisement platform 230 may select advertisements for delivery to the client device 210 based on the ANID. The advertisement platform 230 also receives a log 219 from the client device 210 or the mail server 220. The advertisement platform 230 parses the log 219, categorizes the sender domains contained in the log 219, selects advertisements that correspond to the categorized sender domains, and updates recipient profiles for recipients of a message having the categorized sender domain. Alternatively, the advertisement platform 230 may parse the safe list, categorize the sender domains contained in the safe list, select advertisements that correspond to the categorized sender domains, and update recipient profiles for recipients of a message having the categorized sender domain using an ANID that corresponds to the safe list.

In some embodiments, the advertisement platform 230 includes a targeting component 231, an anonomizer component 232, an analysis component 233, an advertisement selection component 234, and a delivery engine component 235. The targeting component 231 receives the log 219 or safe list. The targeting component 231 extracts the sender domains from the log 219 or safe list. The targeting component 231 generates full sender domains from the extracted sender domains. In one embodiment, the targeting component 231 performs a query using the sender domain to determine a full sender domain for the extracted sender domain. For instance, the targeting component 231 may extract the sender domain “@senderdomain.com” from the log. In turn, the sender domain performs a database search to locate public content having the sender domain “senderdomain.com.” The targeting component 231 processes the public content and extracts a full sender domain for “XYZ” Corporation, located in Seattle, specializing in “R” product and “O” services. In some embodiments, the full sender domains include, a name for an entity that corresponds to the sender, a location of the sender, and a list of products or services provided by the sender. The targeting component 231 transmits the full sender domains to the analysis component 233 for categorization. Also, the targeting component 231 may transmit the ANID and actions—stored in the log or safe list—associated with each full sender domain derived from the extracted sender domains to the anonomizer component 232.

The anonomizer component 232 receives the ANIDs for each log or safe list from the targeting component 231. In one embodiment, the anonomizer component 232 communicates with an identification system 240 to obtain recipient profiles 249. The anonomizer component 232 requests the recipient profiles 249 using the ANIDs. The identification system 240 receives the request from the anonomizer component 232 and obtains the recipient profiles 249 based on the ANIDs. The recipient profile 249 includes explicit recipient data and implicit recipient data. The anonomizer component 249 transmits the recipient profiles 249 to the analysis component 233 for updating based on categorization of sender domains received by the recipients associated with recipient profiles 249.

The analysis component 233 categorizes, for each ANID, the full sender domains derived from the extracted sender domains and any available actions that correspond to the extracted sender domains. The analysis component 233 also updates the recipient profiles 249 to include implicit recipient data based on the categorized full sender domains. In an embodiment, the analysis component 233 traverses database 250 to map the full sender domains to one or more advertiser categories. For instance, the analysis component 233 may determine a full sender domain is associated with a retail advertiser category or travel advertiser category based on the data supplied by the targeting component 231 and the mappings included in the databases 250. In an embodiment, the databases 250 maps the terms included in the full sender domain to the advertiser categories. For instance, the databases 250 may map a full sender domain having the term “recreation” to a sports advertiser category, a travel advertiser category, or a photography advertiser category. In turn, the analysis component 233 receives the advertiser categories for each full sender domain from the databases 250 and stores the advertiser categories as implicit recipient data in the recipient profiles 249 that correspond to the ANIDs associated with the full sender domain. The analysis component 233 transmits the updated recipient profiles 249 to the advertisement selection component 234 and to the identification system 240 via the anonomizer component 232. The identification system 240 stores the updated recipient profiles. In some embodiments, the analysis component 233 prioritizes the advertiser categories received from the database based on the actions associated with the full sender domain. A reply, label, print, or forward action that corresponds to the full sender domain increases the priority of the advertiser categories associated with the full sender domain. For instance, the analysis component 233 may assign a lower priority to advertiser categories of a full sender domain having only a read action and a higher priority to advertiser categories to another full sender domain having a reply or forward action. The priorities assigned to the advertiser categories are stored in the updated recipient profiles 249 and are used by the advertisement selection component 234 to select advertisements for transmission to the recipient. The assigned priorities for each advertiser category, the advertiser category, and ANID are transmitted to the delivery engine component 235 to schedule delivery of the selected advertisements.

The advertisement selection component 234 receives the updated recipient profiles 249 from the analysis component 233. In turn, the advertisement selection component 234 queries the databases 250 for advertisements. The advertisement selection component 234 extracts the explicit recipient profile data and implicit recipient profile data from the updated recipient profiles 249 for each ANID. The advertisement selection component 234 generates queries using the explicit recipient profile data and implicit recipient profile data. The queries are issued to the database 250 to retrieve advertisements that match the terms included in the queries. The retrieved advertisements may be supplemented by the advertisement selection component 234. In one embodiment, the retrieved advertisements are supplemented based on, among other things, context, behavior, timing, proximity, and performance. The retrieved advertisements for each ANID, the supplemented advertisements, the ANID, and advertiser category for each retrieved advertisement and each supplemented advertisements are transmitted to the delivery engine component 235. In some embodiments, the advertisement selection component 234 may retrieve advertisements for recipients that are not associated with an ANID and corresponding recipient profile 249. Accordingly, the advertisement selection component 234 may use context, behavior, timing, proximity, or performance, to select advertisements for delivery to recipients that are not associated with an ANID and corresponding recipient profile 249.

The delivery engine component 235 transmits scheduled advertisements 239 to recipients via a rendering device 215 at the client device 210. The delivery engine component 235 receives the advertiser category priorities for each ANID from the analysis component 233. The delivery engine component 235 uses the advertiser category priorities associated with each ANID to schedule delivery of advertisements to the recipient corresponding to the ANID. The retrieved advertisements and supplemental advertisements provided by the advertisement selection component 234 are clustered based on advertiser category. In turn, the clusters may be organized based on priority of advertiser category. In one embodiment, clusters of advertisements 239 for each ANID are selected by the delivery engine component 235 for transmission to the recipient, where the advertisement category having the highest priority are the first group of advertisements sent to the recipient associated with the ANID. The rendering device 215 receives the advertisements and renders the advertisements on the client device 210. In an alternate embodiment, when an ANID is unavailable, the delivery engine component 235 randomly schedules that advertisements received from the advertisement selection component 234 for delivery to the recipient.

The identification system 240 is a server that anonomizes the recipient profiles 249. In some embodiments, the anonmizer component 232 may be separate from the advertisement platform 230 and may execute on the identification system 240. The identification system 240 may receive authentication data, e.g., a recipient's username and password (PUID) from the client device 210 or mail server 220. The PUID is a personalized identifier of the recipient. In turn, the identification system 240 performs a one-way hash on the PUID received from the recipients to generate an ANID for each recipient. The ANID is a non-personalized identifier. The profiles database 170 stores the ANID for each recipient. In some embodiments, the profiles database stores recipient profiles 249 having explicit recipient data and implicit recipient data for each ANID. The advertisement platform 230 may request a recipient profile 249 from the identification system 240 using the ANID. The identification system 240 traverses the profiles database using the ANID and responds with the appropriate recipient profile 249. The profiles database is also updated with implicit user data that is provided by the advertisement platform 230 based on the categorized sender domains associated with each recipient. The implicit user data may include advertiser categories selected by the advertising platform 230.

Accordingly, the advertisement platform 230 transmits advertisements to recipients based on the advertiser categories corresponding to the sender domains. The advertisements may be scheduled according to priorities that are assigned by the advertisement platform 230. The priorities of each advertiser category are related to the actions performed by the recipients. In other embodiment of the invention, the targeting component 231, the anonomizer component 232, the analysis component 233, the advertisement selection component 234, and the delivery engine component 235 may each execute separately and independently on different server devices as opposed to one server device executing the advertisement platform 230.

In some embodiments, the advertiser categories are determined by traversing a taxonomy that maps full sender domains to advertiser categories. The taxonomy may be a hierarchical tree that organized the advertiser categories and terms that correspond to each advertiser category. The advertisement platform traverses the taxonomy to select advertiser categories for each sender domain associated with each ANID received from a client device operated by a recipient of electronic messages.

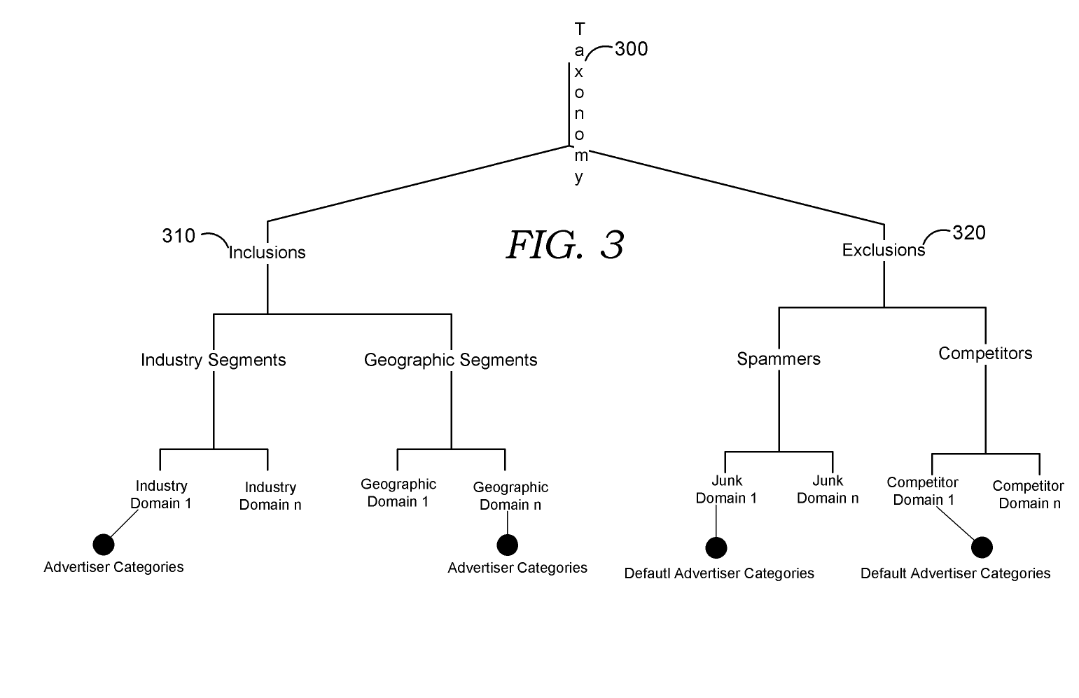

FIG. 3 is a data model diagram that illustrates an exemplary taxonomy 300 in accordance with embodiments of the invention. The taxonomy 300 specifies inclusions 310 and exclusions 320. In some embodiments, the taxonomy is stored in an advertisement database. The inclusions 310 represent the set of sender domains for which various advertiser categories are available. The exclusions 320 represent the set of sender domains for which default advertiser categories are available.

The inclusions 310 include segment nodes that may represent industries and geographic regions. The industry and geographic segment nodes include children nodes that represent the various industry domains and geographic sender domains. In turn, each industry domain and geographic domain include children nodes that represent the various advertiser categories. For instance, an industry segment may include retail. The industry domains related to the industry segment may include cars and clothes. The advertiser categories may include luxury cars and fuel efficient cars.

The exclusions 320 include nodes that represent entities that should not receive relevant advertisements. The exclusions 320 may include a spammer node and a competitor node. The spammer node may have children nodes that represent junk domains. The competitor nodes may have children nodes that represent competitor domains. The spammer nodes and competitor nodes each have children nodes that represent default advertiser categories. For instance, a spammer segment may include spammer domains or network addresses for spammer devices. The junk domains related to the spammer segment may include “junk offers” and “junk products.” In one embodiment, the default advertiser categories may include travel or clothes.

The advertisement platform may traverse the taxonomy 300 with the full sender domain. In certain embodiments, the advertisement platform obtains advertiser categories from segments of the taxonomy that match terms included in the full sender domain. The advertisement platform associates the advertiser categories with the ANID associated with the sender domain having the matching terms.

In certain embodiments, the advertisement platform updates the recipient profile based on the advertiser categories selected for each sender domain associated with the ANID. The recipient profile stores explicit recipient data and implicit recipient data. The implicit recipient data is updated to include the advertiser categories associated with a recipient corresponding to the ANID. In some embodiments, the implicit recipient data includes priorities assigned to the advertiser categories based on the actions performed by the recipients.

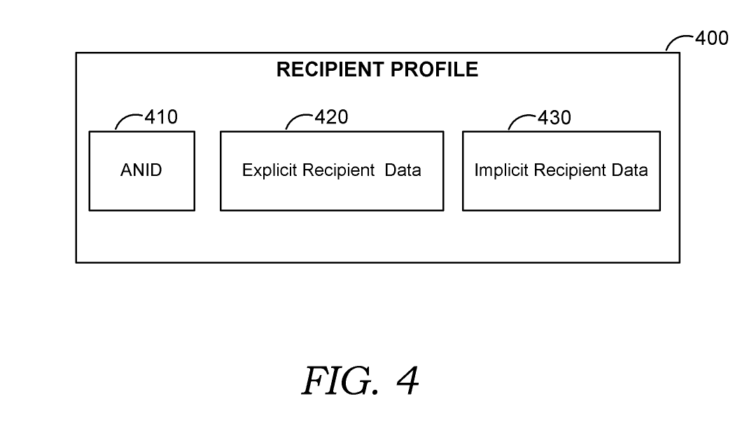

FIG. 4 is a structural diagram that illustrates an exemplary user profile 400 in accordance with embodiments of the invention. The recipient profile 400 may include an ANID 410, explicit recipient data 420, and implicit recipient data 430. In some embodiments, the recipient profiles 400 are stored at the identification system.

The ANID 410 is the anonymous identifier for the recipients. Each recipient profile has a separate ANID. The explicit recipient data 420 includes inputs received from a recipient during registration with a mail server. The explicit recipient data 420 may include subscription data for a magazine, catalog, or newsletter that the recipients chose. In some embodiments, the explicit recipient data 420 is used by the advertisement platform to select appropriate content, including advertisements, for deliver to the recipient. The implicit recipient data 430 includes the advertiser categories selected by the advertisement platform and the priorities for each advertiser category. The recipient profile 400 is used by the advertisement platform to target advertisement to the recipients. The advertisement platform may provide realtime categorization of sender domain and realtime delivery of content to the recipients based on the recipient profile 400. The realtime categorization and delivery provides a recipient with synchronous experiences, where content corresponding to the recipient profile 400, log, and a sender domain of a message currently displayed to the recipient is delivered to recipient. In other embodiments, an asynchronous experience provides content to the recipient after processing the recipient profile 400 and log without regard to the sender domain of a message currently displayed to the user.

In some embodiments, the advertisement platform is configured with processor and computer-readable media for identifying advertiser categories. The advertisement platform executes a computer-implemented method to identify advertiser categories for sender domains received from recipients operating various client devices. The advertiser categories are used by the advertisement platform to update recipient profiles and to target advertisements to the recipients.

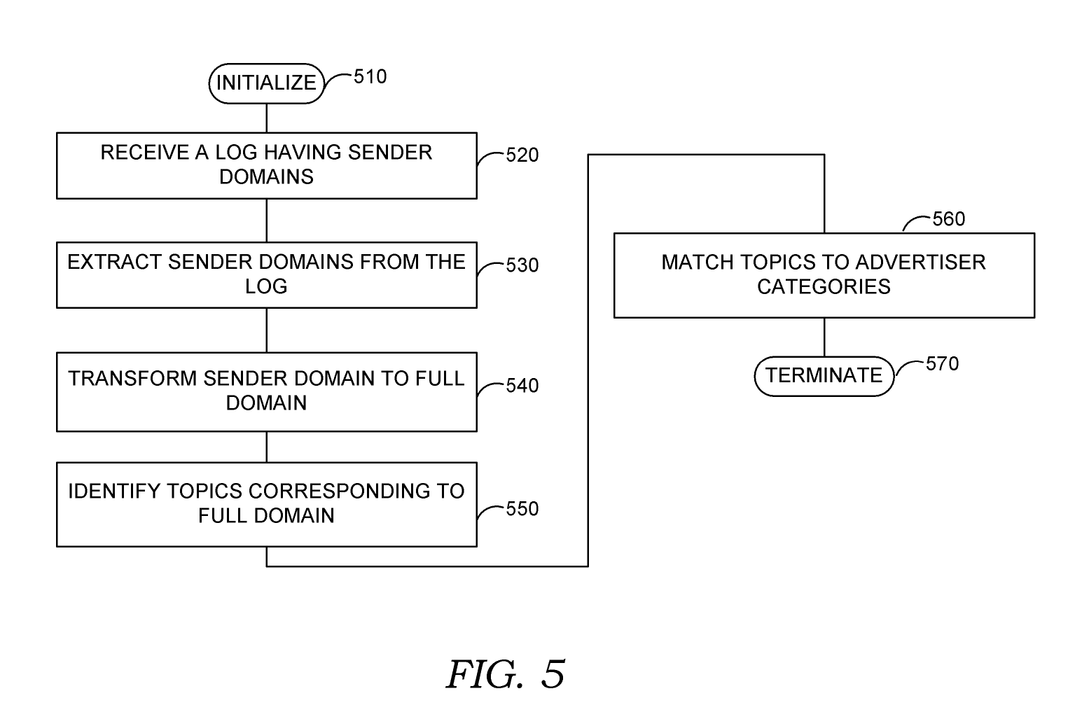

FIG. 5 is a logic diagram that illustrates a computer-implemented method to identify advertiser categories for sender domains in accordance with embodiments of the invention. The method initializes in step 510 when the advertisement platform is powered on at an advertisement facility. The advertisement platform receives logs having sender domains from client devices operated by recipients, in step 520. The log includes an action performed by a recipient of the electronic mail. The action may include any one of: read, save, label, junk, delete, print, reply, forward, hover, spend a threshold amount of time reading (e.g. 10 sec.), forward to a threshold number of people (e.g. 3), move to another folder, tag, categorize, or print. The advertisement platform receives an anonymous identifier (ANID) for each recipient of an electronic mail from the sender domains. In step 530, the advertisement platform extracts sender domains from the log. The advertisement platform transforms the extracted sender domain to a full sender domain in step 540. In turn, the terms and topics corresponding to full sender domains are identified by the advertisement platform in step 550. In step 560, the advertisement platform matches the one or more topics and terms with advertiser categories via a taxonomy that maps the one or more topics and terms to advertiser categories. The advertisement platform links advertising categories to sender domains and weights a link between each sender domain and a corresponding advertising category based on recipient action. The various recipient actions may be assigned weights. For instance, forward may have a 0.1 weight, print may have a 0.01 weight, and delete may have a 0.0001 weight. In some embodiments, the weight correspond to a link is increased if a recipient reads and forwards an electronic mail from the sender domain as opposed to read only. In some embodiments, the weights assigned to the links may be used as priorities by the advertisement platform when scheduling delivery of advertisements. The method terminates in step 570.

In some embodiments, a mail server provides the logs having ANIDs, actions, and sender domains to the advertisement platform. The mail server receives electronic messages from the senders and delivers the electronic messages to the recipients. In turn, the mail servers record actions performed by the recipient of the electronic messages. The actions and sender domains associated with each domain are transmitted to the advertisement platform by the mail server.

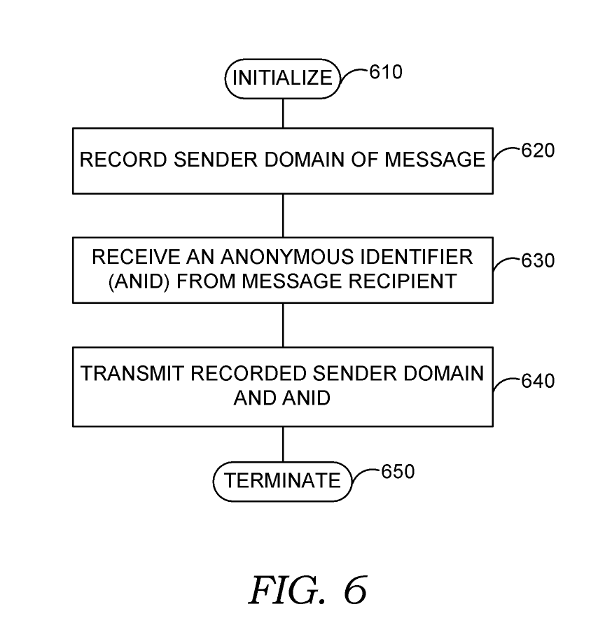

FIG. 6 is a logic diagram that illustrates a computer-implemented method to target advertisements based on sender domains in accordance with embodiments of the invention. The method initializes in step 610 when the mail servers are powered on at a mail facility. In step 620, the mail servers records a sender domain for each message received by each client device that displays the received messages to recipients that read the message. The client device is a computer, x-box, or some other computing device configured to connect to the mail server. In step 630, the mail servers receives from the client devices, a personal user name and personal password (PUID) or an anonymous identifier (ANID) for each authenticated recipient at the mail servers. Additionally, the mail servers receive actions taken by the client device. The mail servers transmit the recorded sender domains and corresponding ANID from the one or more mail servers to the advertisement platform, in step 640. The ANID allows the client device to receive advertisements across various applications linked to the advertisement platform. The advertisement platform is configured to identify a category for the sender domain without accessing the content of the message, infer additional data corresponding to interests of the recipient, and update a profile associated with each ANID. The method ends in step 650.

In summary, the advertisement platform allows a recipient of electronic messages to receive advertisements that are targeted to the recipient based on classifications of sender domains in the received electronic messages. The advertisements may be transmitted to the recipient in realtime. The advertisement platform categorizes the sender domains based on actions performed by the recipient and mapping contained in a taxonomy. The advertisement platform enables anonymous identification of recipients and protection of a recipient privacy when targeting advertisements to the recipient.

The foregoing descriptions of the embodiments of the invention are illustrative, and modifications in configuration and implementation are within the scope of the current description. For instance, while the embodiments of the invention are generally described with relation to FIGS. 1-6, those descriptions are exemplary. Although the subject matter has been described in language specific to structural features or methodological acts, it is understood that the subject matter defined in the appended claims is not necessarily limited to the specific features or acts described above. Rather, the specific features and acts described above are disclosed as example forms of implementing the claims. The scope of the embodiment of the invention is accordingly intended to be limited only by the following claims.

We claim:

1. One or more computer-readable media storing computer-usable instructions that cause one or more processors to perform a method that identifies one or more advertiser categories for a sender domain, the method comprising:
receiving a log having sender domains;
extracting sender domains from the log;
transforming the extracted sender domains into full sender domains;
identifying one or more topics that correspond to each full sender domain; and
matching the one or more topics with advertiser categories via a taxonomy that maps the one or more topics to advertiser categories.

2. The media of claim 1, further comprising: receiving an anonymous identifier (ANID) or personal user name and personal password for each recipient of an electronic mail from the sender domains.

3. The media of claim 2, further comprising: inferring interests of recipients associated with each ANID based on the advertiser categories selected from matches in the taxonomy.

4. The media of claim 3, further comprising: updating a profile corresponding with each ANID to include the inferred interests.

5. The media of claim 1, wherein the log includes an action performed by a recipient of the electronic mail.

6. The media of claim 5, wherein each action is assigned a weight and the actions are one of: read, save, label, delete, junk, print, reply, forward, hover, spend a threshold amount of time reading, forward to a threshold number of people, move to another folder, tag, categorize, or print.

7. The media of claim 6, further comprising: linking advertising categories to sender domains and weighting a link between each sender domain and a corresponding advertising category based on recipient action and assigned weight, wherein the weight is increased if a recipient reads and forwards an electronic mail from the sender domain as opposed to read only.

8. The media of claim 6, wherein transforming the extracted sender domains into full sender domains further comprises:
searching for web pages corresponding to the sender domains.

9. The media of claim 7, wherein the topic is included in the web pages corresponding to the sender domains.

10. A computer-implemented method to target advertisements based on sender domains received by an advertisement platform, the method comprising:
recording, at one or more mail servers, a sender domain for each message received by each client device that displays the received messages to recipients that read the message;
receiving, from the client device, an anonymous identifier (ANID) for each authenticated recipient at the one or more mail servers; and
transmitting the recorded sender domains and corresponding ANID from the one or more mail servers to the advertisement platform.

11. The method of claim 10, wherein the client device is a computer, gaming station, or some other computing device configured to connect to the mail server.

12. The method of claim 10, further comprising: receiving, at the one or more mail servers, actions taken by the client device.

13. The method of claim 10, wherein the ANID allows the client device to receive advertisements, in realtime, across various applications linked to the advertisement platform.

14. The method of claim 10, wherein the advertisement platform identifies a category for the sender domain without accessing the content of the message, infers additional data corresponding to interests of the recipient, and updates a profile associated with each ANID.

15. An advertisement system, the advertisement system comprising:
one or more databases communicatively connected to one or more targeting systems, the one or more databases configured to store relationships between sender domains and advertiser categories;
one or more electronic mail servers communicatively connected to the one or more targeting systems, the one or more electronic mail servers configured to provide e-mails to an authenticated recipient via an e-mail client executing on a client device, and recording sender domains for e-mails read by the recipient; and
the one or more targeting systems configured to receive a log having sender domains recorded by each of the one or more e-mail servers, the one or more targeting systems further configured to determine relevance of each sender domain in the log to a plurality of advertisement categories stored in the one or more databases.

16. The advertisement system of claim 15, wherein the one or more databases includes a taxonomy that maps a sender domain to one or more advertiser categories.

17. The advertisement system of claim 15, wherein each client device stores an anonymous identifier (ANID) for each recipient.

18. The advertisement system of claim 17, wherein the one or more electronic mail servers stores the ANID in the log along with the sender domain and an action performed by the recipients of messages having the sender domain.

19. The advertisement system of claim 18, wherein sender domains in the log include sender domains included on a safe list managed by the recipient.

20. The advertisement system of claim 17, wherein the one or more targeting systems determine relevance of the sender domain and corresponding advertiser categories based on an observed frequency of the sender domain in the log.
